(19) United States
(12) Patent Application Publication
(10) Pub. No.: US 2003/0095660 A1
(43) Pub. Date: May 22, 2003

(54) System and method for protecting digital works on a communication network

(75) Inventors: Chang Young Lee, Seoul (KR); Cheol Woong Lee, Fort Lee, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Overpeer, Inc., New York, NY

(21) Appl. No.: 10/246,858

(22) Filed: Sep. 19, 2002

Related U.S. Application Data
(63) Continuation-in-part of application No. 09/977,894, filed on Oct. 15, 2001.

(51) Int. Cl. G06F 17/60

(52) U.S. Cl. 380/231; 705/51

(57) ABSTRACT

Disclosed herein is a system and method for protecting digital works on a communication network. The work protection system includes one or more intermediate servers, one or more list provision servers and a work protection server. The intermediate servers perform intermediation of data shared. The list provision servers provide list information of the intermediate servers. The work protection server connects with a corresponding intermediate server, searches for shared digital works, calculates a saturation or dilution by examining the presence of identifiers, generates file and connection information about digital files to be shared, and causes the previously stored files of digital works to be protected to be shared.

### RELATED APPLICATIONS

The present application claims priority from and is a continuation-in-part of U.S. patent application Ser. No. 09/977,894 entitled “System and Method of Sharing Digital Literary Works While Protecting Against Illegal Reproduction Through Communication Network”; U.S. patent application Ser. No. 09/977,895 entitled “Method of Preventing Reduction of Sales Amount of Records due to Digital Music File Illegally Distributed Through Communication Network” and U.S. patent application Ser. No. 09/977,896 entitled “Method of Preventing Reduction of Sales Amount of Records due to a Digital Music File Illegally Distributed Through Communication Network”, all of which were filed Oct. 15, 2001 and the contents of each of which are incorporated in their entirety herein.

### FIELD OF THE INVENTION

The present invention relates generally to a system and method for protecting digital works on a communication network, and more particularly to a system and method for protecting digital works on a communication network, which is capable of searching for pirated works, generating digital files to cope with the pirated works and distributing the generated digital files through the communication network so as to reduce the likelihood that the pirated works will be circulated through a peer-to-peer type shared network.

### BACKGROUND OF THE INVENTION

Recently, as the development and popularization of peer-to-peer (referred to as “P2P” hereinafter) type programs increase, the illegal circulation of works is widely performed via a P2P type shared network. P2P is a type of transient network in which users connecting with one another through a communication network, such as the Internet, directly connect with one another's computers through a P2P-only application and transmit and receive various information, data and files. That is, P2P denotes a shared network, in which personal computers directly connect with and search one another, as such all participants are suppliers and consumers at the same time. This shared network approach differs from a standard client/server model. P2P can be implemented by a method in which connections among individuals can be achieved with the aid of a server and another method in which individuals share personal information, such as Internet Protocol (IP) addresses, and directly connect with one another without the aid of a server. In such a case, peers that connect with one another designate digital devices such as computers, Personal Digital Assistants (PDAs), mobile phones and the like. The representative examples of such a P2P shared network are “Napster” developed in the United States and “Soribada” developed in Korea.

However, P2P sharing of files causes various problems related to distribution rights, specifically infringement of the copyrights existing in the digital work. In the P2P network environment digital works, are freely duplicated and interchanged without permission of copyright holders in a simple and easy manner. Accordingly, demands for the protection of copyright of digital contents from infringements are increasing. The need exists to develop a method that thwarts users of the P2P network, i.e., potential infringers, from obtaining illegal copies of protected digital works.

### SUMMARY OF THE INVENTION

Accordingly, the present invention has been made to address the problems in the prior art and an object of the present invention is to provide a system and method for protecting digital works on a communication network. The method and system of protecting digital works on a communications network is capable of searching for unauthorized or illegal works that have distributed via a peer-to-peer (P2P) type shared network. In response to the search for unauthorized or illegal files the system and method generates and distributes authorized or legal digital files to mitigate the proliferation of unauthorized or illegal copies existing on the network. In this manner, the present invention prevents distribution of unauthorized and illegal copies of digital works, thus providing incentive to authors and developing related industries. Another object of the present invention is to provide a system and method for protecting digital works on a communication network, which is capable of selecting one of various distribution options for disseminating authorized or legal digital files on the communication network. The distribution options include, a “no-download” option, a redirection option, and a corrupt/encrypt digital file option. By providing multiple distribution options the present invention can satisfy the various demands of those which hold the rights in the protectable digital works.

In order to accomplish the above object, the present invention provides a system for protecting digital works on a communication network, the digital works being shared in a peer-to-peer manner via the communication network among a plurality of user terminals. The system includes one or more intermediate servers for performing intermediation of data shared via the communication network, one or more list provision servers for providing list information of the intermediate servers; and a work protection server. The work protection server is capable of connecting with a corresponding intermediate server according to list information provided by the list provision server, searching for digital works shared via the intermediate server using a preset search condition, calculating a detected saturation value by examining the presence of identifiers in the files of the searched digital works, generating file and connection information about digital files to be shared, and causing the previously stored files of digital works to be shared on the communication network.

Preferably, the work protection server may comprise a main server for (a) connecting with a corresponding intermediate server, (b) searching for digital works shared via the intermediate server using preset search conditions, (c) calculating the detected saturation value by receiving the searched digital works and examining the presence of identifiers in the files of the searched digital works, and (d) generating file and connection information about digital files to be shared. Additionally, the work protection server may include one or more auxiliary servers for (a) receiving the file and connection information about digital works to be shared via the communication network, (b) connecting with the intermediate server and (c) causing the digital works to be shared on the communication network.

In addition, the present invention provides a method of protecting digital works on a communication network, the digital works being shared in a peer-to-peer manner via the communication network among a plurality of user terminals. The method includes the steps of generating information about works to be protected and digital work files by inputting a chosen distribution option, inserting identifiers, and registering and storing the inputted information in a work protection server. The distribution options may include a distortion/noise/encryption option, a “no-download” option or a redirection option. In addition, the method may include the steps of searching for works shared on the communication network, and determining whether the searched works are unauthorized copies of the work by examining the presence of identifiers in the files of the searched works and having the work protection server distribute stored authorized digital work files to mitigate the proliferation of unauthorized copies in the communication network In an alternate method, the work protection server transmits to a user terminal the authorized digital files in the form of a digital file list, a distorted/noisy/encrypted file or a file having redirection specified according to a set option when the user terminal requests transmission of the shared digital work files.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of a system for protecting digital works on a communication network in accordance with one embodiment of the present invention;

FIG. 2 is a flowchart schematically showing the digital work protection method of one embodiment of the present invention;

FIG. 3 is a flowchart showing a process of generating and registering digital work files in accordance with one embodiment of the present invention;

FIG. 4 is a flowchart showing a process of searching for unauthorized or illegal digital works shared on a communication network and generating files and connection information to mitigate the distribution of the unauthorized or illegal digital works, in accordance with an embodiment of the present invention;

FIG. 5 is a flowchart showing a process of connecting with a corresponding intermediate server under the control of the main server and causing digital works to be shared, in accordance with an embodiment of the present invention; and

FIG. 6 is a flowchart showing a process of being redirected to a corresponding Web site, in accordance with an embodiment of the present invention.

### DESCRIPTION OF THE PREFERRED EMBODIMENTS

The present invention now will be described more filly hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

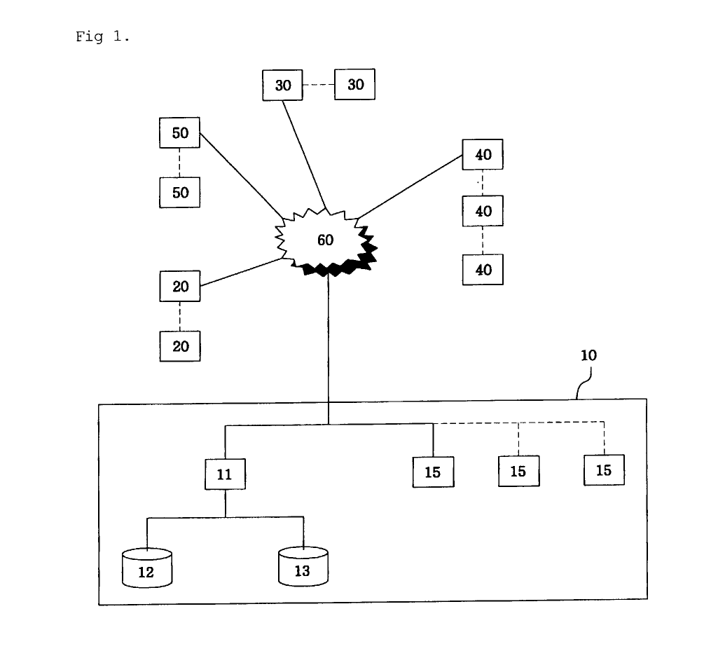

FIG. 1 is a schematic block diagram of a system for protecting digital works on a communication network in accordance with the present invention. The system for implementing the present invention is comprised of a work protection server 10, one or more list provision servers 20, one or more intermediate servers 30, a plurality of user terminals 40, and a communication network 60 for connecting the components of the system to one another to transmit/receive data to/from one another. Additionally, the work protection system of the present invention may include one or more Web servers 50 that can connect therewith through redirection via the communication network 60, that is, servers managed by authors, or manufacturing or circulating companies.

The communication network 60 is a wire or wireless network that is capable of allowing the work protection server 10, the list provision servers 20, the intermediate servers 30, the user terminals 40 and the Web servers 50 to perform data communication therebetween. A representative example of the communication network 60 is the Internet, although other communication networks are also feasible and within the inventive concepts herein disclosed.

The user terminals 40 are devices that are capable of transmitting/receiving digital work data to/from one another. The user terminals 40 include a variety of digital devices such as computers, PDAs, mobile phones and the like.

The intermediate servers 30 function to intermediate between users to allow the users to share digital works via the communication network 60 in a P2P shared network environment.

The list provision servers 20 function to provide lists such as IP addresses, port numbers or the like. The list provision servers 20 are intermediate servers with which the user terminals 40 first connect when a certain search program is executed. The connecting information of the user terminals 40, that is, IP addresses or port numbers, are provided to the list provision servers 20 at the same time the user terminals 40 first connect with the list provision servers 20.

The work protection server 10 accesses a corresponding intermediate server 30 according to list information provided by the list provision servers 20, searches for digital works shared by the intermediate server 30 using a preset search condition to detect the current saturation (also known as dilution) that is a ratio of the number of pass determinations to the total number of determinations, determines the number of files to be shared to achieve a preset target saturation, and generates the file information and connecting information of the files to allow the work files to be shared. Additionally, for files to which a redirection function is set, when these files are executed, redirection to a corresponding Web server 50 is carried out.

The work protection server 10 may be comprised of a main server 11 and one or more auxiliary servers 15. The main server 11 accesses a corresponding intermediate server 30 through the communication network 60 according to list information provided by the list provision servers 20, searches for digital works shared through the intermediate server 30 using a preset search condition, receives searched digital works, determines whether the searched digital works are illegal by determining whether the searched digital works include corresponding identifiers and thereafter determines the current saturation, determines the number of files to be shared to achieve a preset target saturation, and generates the file and connecting information of the files to be shared. The main server 11 is provided with a storage unit 12 and a database 13.

The auxiliary servers 15 receive the file and connecting information of files to be shared from the main server 11 through the communication network 60, access the intermediate servers 30, and allow digital works to be shared.

The main server 11 can connect with the auxiliary servers 15 through a short-distance network such as a Local Area Network (LAN). For the security of an internal system, it is preferable to selectively allow access from the outside to the internal system in such a way that private IP addresses are employed for access from the inside and public IP addresses are employed for access from the outside by using existing switching equipment.

A preferred embodiment of a method of protecting digital works on a communication network in accordance with the present invention is described in detail below.

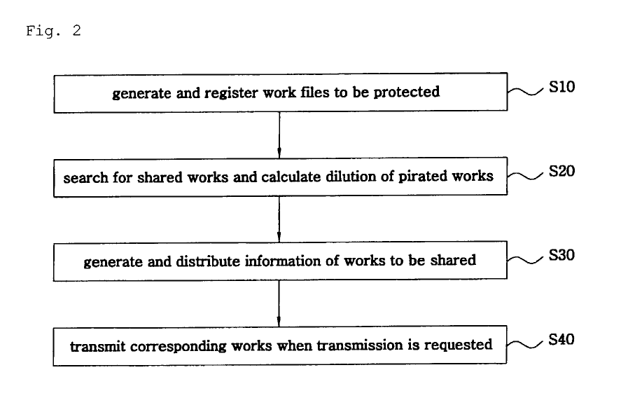

FIG. 2 is a flowchart schematically showing the digital work protection method of the present invention.

At step 70, an administrator generates, registers and stores the protected digital work in the work protection servers 10. Generating and registering the files will include inputting identification information about the digital work and information related to the level of protection that is assigned to the work. In accordance with the present invention, the levels of protections may include (a) corrupting or encrypting the work, (b) designating the work as non-downloadable, or (c) redirecting the user who desires to download the file to a related Web site. In addition, identifiers may be inserted in the digital work file to identify the file as a legally obtained copy of the protected work. At step 80, the work protection server 10 accesses a corresponding intermediate server 30 according to list information obtained from the list provision servers 20, searches for files corresponding to individual copies of a specified digital work that have been shared through the communication network 60, and determines for each file found in the search, whether the file contains an illegally or legally distributed copy of the work. Determination of the legality of the distributed copy will typically be established by recognizing an identifier inserted into the file by the administrator at step 70 with those files having the identifier being considered legal and those files lacking an identifier being considered illegal. Additionally, at step 70, the detected saturation value is determined. The detected saturation value is calculated as the ratio of legally distributed copies of a work currently available on the network versus the total number of copies of the distributed work currently on the network.

Thereafter, at step 90, the work protection server 10 first determines the number of files that the digital work protection system of the present invention must share with the P2P file sharing network. This determination is made by comparing the detected saturation value with predetermined target saturation. The predetermined target saturation defines the percentage of legally or authorized distributed copies of a protected work that the authors or copyright holders desire to exist in the communication network. In this instance, legal or authorized distributed copies would include corrupted or encrypted files, “non-downloadable” files or redirection files. For example, if the protected work has been assigned a predetermined target saturation of 90 percent, the network currently comprises 100 files of the digital work and the detected saturation is 50 percent (i.e., 50 files being legal and 50 files being illegal) then the system must share 400 files with the P2P file sharing network in order to result in the desires predetermined target saturation (i.e., 450 of the 500 total files then on the network will be legal). Once the number of files to be shared has been determined the system distributes the digital work files stored therein through the communication network 60 as a means of saturating the communication network with legal or authorized copies of the work.

Thereafter, at step 100, when the transmission of a shared file is requested by a user terminal 40, the work protection server 10 transmits a file list or the shared file to the user terminal 40 according to the condition preset for the shared files. In accordance with the present invention, the preset conditions may include a) transmitting a corrupt or encrypted file of the work to the user, (b) transmitting a file list to the user as a means of notifying the user that the file is not downloadable, or (c) transmitting redirection information (i.e. a hyperlink) to the user for the purpose of redirecting the user to an associated Web site. The preset conditions are set by the administrator for a given file at step 70.

Through the above-described process, the network circulation of illegal distributed copies of digital works can be reduced by generating and distributing files into which identifiers are inserted through the communication network 60 to cope with pirated duplicates.

The method for digital work protection in a P2P file sharing network, according to a preferred embodiment of the present invention, is described in more detail below.

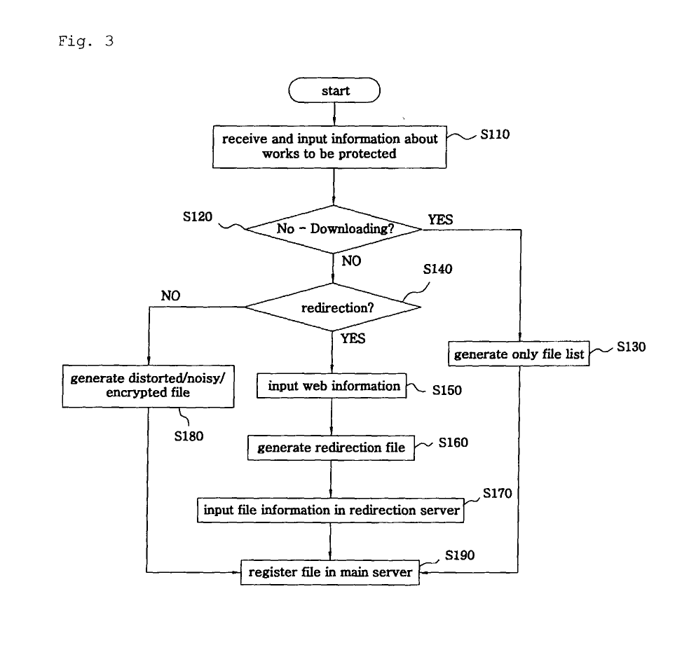

First, step 70 of FIG. 2, generating and registering digital work files is shown in more detail in the flow diagram of FIG. 3, in accordance with an embodiment of the present invention.

An administrator receives work files to be protected and/or information related to the work files from clients or those desiring digital work protection and inputs the work files and related information to the main server 11 at step 110. In this case, the clients may be authors who created the digital works and/or copyright holders who deal in and distributes the digital works. For example, the clients may be performers, authors, music producers, publishers, film distributors and software companies, and the like.

Information relating to the works, which the administrator obtains from the clients and inputs, may include the types of distributed files, the authors, the performers, the titles of the digital work, the file names of the works, the track numbers and the like. Additionally, the information may include the network addresses of original files or Web servers at clients' option.

Protection of the inputted files within the network can be accomplished by designating the files according to protection options. These options include, but are not limited to, (a) corrupting or encrypting the work, (b) designating the work as non-downloadable, or (c) redirecting the user who desires to download the file to a related Web site.

First, at step 120, a determination is made whether the “no-download” option has been designated by the client for a particular work file. Files designated as “no-download” or “non-downloadable” will not be downloadable via the P2P filing sharing communication network 60 and the user who searches for that particular file and selects the distributed “non-downloadable”file will be provided with an index list (also known as a file list) and notified that downloading of the digital work is not allowed and the user. As such, at step 130, if the “non-downloadable” option is selected, then no file of the digital work is generated but an index list related to the file is generated, and, at step 190, the index list is registered in the memory module of the main server 11. If the no-downloading option is not selected, a file, such as a corrupted or encrypted file or a file containing redirection information, is generated and shared on the communication network 60.

Thereafter, at step 140, a determination is made whether the redirection option has been designated by a client for a particular work file. The redirection option provides for the work file to be linked to a redirection file. As such, users of the P2P file sharing network that desire to download the work file are instead provided with the redirection file that will automatically open a Web browser and direct the user to the copyright holder's Web site, typically related to the work file or a similar sales promotion Web site. Thus, if a determination is made that the redirection option is required then, at step 150, the related Web information, i.e., associated URL address and the like, is linked to the work file. To this end, file information and author information may be related to each other on the database of a redirection Web server, so the database functions as an interface for connecting users with authors. In other words, the redirection option may redirect the user to a Web site, as identified by a URL address, that provides information about the particular digital work for which the user searched, as well as additional information about the author or other copyright owner and their other works. The redirection file also generally includes a unique identifier or ID, as described below.

After the above-described information is inputted into the work file, a redirection file is generated, at step 160, using a tool, such as Windows Media Rights Manager (WMRM), Real System Development Kit (SDK), WinAmp SDK or the like with an unique ID inserted into the file.

Thereafter, at step 170, redirection file information is inputted to the redirection Web server. In this case, inputted redirection file information may include an author's or performer's name, a file name, the unique ID of the file, the address of the linking Web site and the like, typically expressed as a hyperlink in the header of the redirection file.

At step 190, the generated work file that has been designated for redirection is registered for service in the main server 11 and distributed through the P2P file sharing communication network 60.

If the “no-downloading” option is not selected and the redirection option is not selected then, at step 180a protected digital file is generated according to the corruption/encryption option.

The file generated according to the corruption/encryption option is a public relations (PR) digital file, a deteriorated digital file, an encrypted digital file or the like. Typically, the artist or copyright holder will distribute a PR file as a means of marketing or promoting the digital work. For example, the PR digital file may comprise an extracted portion of a complete digital work that allows the user access to a portion of the work as a means of providing preview capabilities to the users. Additionally, the PR digital file may include an inserted advertisement or author's interview into the contents of the file, again for the general purpose of promoting the original work. The extracted portion files and the files with inserted information are assumed to be corrupt files for the purpose of the present invention.

The deteriorated digital file designates a digital work that is produced with the quality of the digital file considerably reduced, for example, a digital music file produced with the quality of sound of an original music file considerably reduced or a digital image file produced with the quality of the image of an original image file considerably reduced. Methods for distorting a digital music file or deteriorating the quality of sound of the digital music file may be exemplified by a method of inserting noise components, such as the advertising voice of a singer or performer, into music, a method of reducing a sampling rate (for example, an MPEG Layer 3 (MP3) type digital file has a sampling rate of about 44.1 kHz), a method of distorting the waveform of sound, and a method of converting multi-channel sound into single channel sound.

The encrypted digital file designates a digital file that is encrypted using a known encryption algorithm. Although any of the symmetric key encryption algorithms and public key encryption algorithms can be employed as the encryption algorithm, it is preferable to employ a public key encryption algorithm in consideration of the allocation of keys. The public key encryption algorithm, also commonly referred to as an asymmetric key encryption algorithm, is characterized in that a key used for encryption is different from a key used for decryption. One of these keys is referred to as a private key, while the other is referred to as a public key. In general, encryption is carried out by the public key, while decryption is carried out by the private key. If the public key encryption algorithm is employed in the present invention, a digital file is encrypted using a public key authenticated by a certain authentication authority and the digital file can be decrypted by an individual having a corresponding private key.

Further details regarding the generation of a corrupted or encrypted file are provided by U.S. patent application Ser. No. 09/977,894 entitled “System and Method of Sharing Digital Literary Works While Protecting Against “illegal Reproduction Through Communication Network”; U.S. patent application Ser. No. 09/977,895 entitled “Method of Preventing Reduction of Sales Amount of Records due to Digital Music File illegally Distributed Through Communication Network” and U.S. patent application Ser. No. 09/977,896 entitled “Method of Preventing Reduction of Sales Amount of Records due to a Digital Music File Illegally Distributed Through Communication Network”, all of which were filed Oct. 15, 2001 and the contents of each of which are incorporated in their entirety herein.

Additionally, one or more predetermined identifiers are inserted into the distorted/noise/encrypted file. The identifiers inserted into the file can be identified only by the administrator. For example, the identifiers may be water marks, and can be inserted into the front, back and both of them of the file. Additionally, the identifier may be a Message Digest (MD5) or Secure Hash Algorithm (SHA1) value that provides for a unique value of a file and can be used as the identifier. A MD5 or SHA1 value is a unique value associated with the file that is assigned to the file by the operating system of a host at the same time the file is generated.

The insertion position of the identifier is determined by the starting position of transmission of a file determined according to a file transfer protocol between the main server 11 and the intermediate server 30. That is, if the main server 11 requests the transmission of a digital file from the intermediate server 30, the identifier is typically inserted into the front of the digital file if the transmission of this digital file from the intermediate server 30 starts from the front of the file, and the identifier is typically inserted into the back of the digital file if the transmission of this digital file from the intermediate server 30 starts from the back of the file.

In the case where a file transfer protocol between the main server 11 and the intermediate server 30 is unclear or the intermediate servers 30 have different file transfer protocols, the identifiers may be inserted into both at the front and back of the digital file.

The insertion position of the identifier is determined by the starting position of transmission of a digital file because the main server 11 will typically only receive a portion of a searched digital file in order to determine whether the identifier exists in this digital file (i.e., whether the digital work file is a legal or authorized distributed copy of the work), as will be described in more detail below.

A process of inputting information related to digital works to be protected, selecting one or more from the above-described options and generating a file is described below.

First, when the administrator applies power or otherwise provides instructions to the main server 11 to operate and execute a search program stored in the main server 11, the search program is loaded in the main memory of the main server 11 and executed by the processor of the main server 11. As described hereinbelow, this search program identifies the illegal or pirated copies of a digital work on the network and determines the current or actual saturation for the respective digital work. When the search program is executed, the main server 11 displays a user interface screen of the search program upon a display unit. On this interface screen, the administrator inputs the information about works to be protected, selects the protection options and generates the file, i.e., the index list for a non-downloadable digital work, a redirection file or a distorted/noisy/encrypted file.

As described above, after the file is generated, the file is registered in the main server 11 at step 190. The work file registered in the main server 11 and information about the work file is stored in the storage unit 12 or database 13 of the main server 11. As will be described later, the main server 11 searches for unauthorized or illegal works circulated through the communication network, and, based upon the number of unauthorized or illegal works that are located and the target saturation for the network, the number of authorized or legal files, that is, the above-described file list (i.e., the “non-downloadable” file), the distorted/noisy/encrypted file and the redirection file, that must be distributed and shared through the communication network in response to a user's query for a respective digital work is determined.

A process of searching for unauthorized or illegal digital works shared on a communication network and thereafter causing files to be shared on the communication network in response to a user's query for a respective digital work so as to dilute the number of unauthorized or illegal copies available on the network is described below, in accordance with an embodiment of the present invention.

First, the main server 11 connects with the list provision servers 20 for the purpose of providing the main server with lists typically identifying the intermediate servers and/or the user terminals in the network by address, accesses the intermediate servers 30 to search for digital works shared through the communication network and detects a saturation by determining whether the searched digital works are illegal or unauthorized works. Thereafter, the number of authorized files to be shared is determined to achieve the predetermined target saturation for files existing in the communication network.

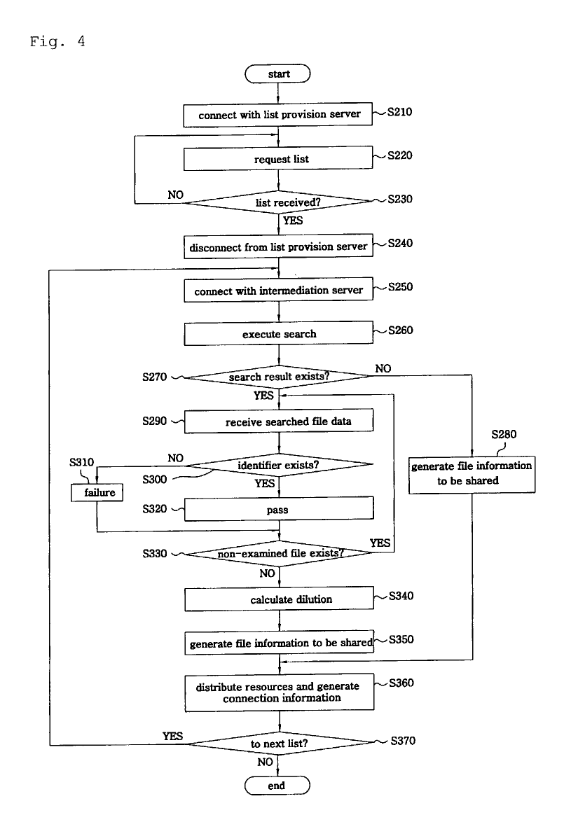

In accordance with an embodiment of the present invention, a process for generating files and connection information to manage unauthorized or illegal copies of digital works in a communication network is described with reference to FIG. 4.

The main server 11 connects with the communication network 60 via network interface equipment. This process is initiated, at step 210, by the main server 11 connecting with the list provision server 20, and, at step 220, requesting the transmission of list information from the list provision server 20 In this case, the network interface equipment is equipment that allows the main server 11 to connect with the communication network 60 to perform data communication. The network interface equipment may be a Channel Service Unit (CSU) or Digital Service Unit (DSU), and may include a router.

At step 230, the main server 11 checks a response from the list provision server 20 and insures that a list has been received. If a list is received, the main server stores the list information in associated memory and, at step 240, disconnects from the list provision server 20. In this case, the list information received from the list provision server 20 can be stored in the storage unit 12 of the main server 11, or in the database 13 of the main server 11 after undergoing schema conversion and mapping. If no list is received in the response from the list provision server, then the main server sends an additional request to the list provision server requesting a list.

After the list has been received and stored, at step 250, the main server 11 connects with the communication network 60 and accesses the intermediate server 30 according to the list information. Connection by the main server with the intermediate server is in accordance with a selection made by an administrator or automatically executed by the search program. In this case, the main server 11 may sequentially access a plurality of intermediate servers 30 in preset access order. The order to access the intermediate servers 30 may be the order of numbers of IP addresses.

At step 260, the main server 11 transmits a preset search condition to the intermediate servers 30, and searches for work files shared on the communication network 60. The search condition is set by the administrator via the user interface screen of the search program for the main server 11. For example, the search condition may be a particular author or performer or a specific title of a work.

Thereafter, at step 270, the main server 11 receives search results from the intermediate servers 30 and determines whether the search results correspond to the preset search conditions. The search results may also include information that will allow the main server to calculate a determined saturation value that corresponds to the percentage of authorized or legal files available in the P2P file sharing communication network. If there are no search results corresponding to the preset search conditions (thereby indicating that there are no digital works of the type that the user requested on the network) then, at step 280, the work protection server 10 generates the files to be shared, i.e., the file list (i.e., the “non-downloadable” file), the distorted/noisy/encrypted file and the redirection file, in accordance with the copyright owner's instructions if these files have not already been generated and stored in the storage unit 12. The work protection server 10 also generates information about the digital files to be shared (such as the file list information identifying the IP address and file feature information that will be provided to a user as the result of a search for the respective digital work) and stores the information in the database 13.

If there are search results corresponding to the preset search conditions then at step 290, the main server 11 receives a portion of the searched digital file from the user terminals 40 that are connecting to the communication network via the intermediate servers 30. A method for receiving portions of the searched digital files may be exemplified by a method in which the main server 11 transmits a request, via the intermediate servers 30 for the transmission of digital files from the user terminals 40. Transmission of the digital files from the user terminals to the main server will ensue until a predetermined portion of the digital file has been transmitted by the user terminal and received by the main server.

The main server 11 receives digital files in order to determine whether the existing network digital files have an identifier inserted within the file. The identifiers, as described above, will indicate whether the digital file is an authorized of legal digital work file. Further, the main server 11 receives a portion of the file because, according to the requisite file transfer protocol, the initial portion of the transmitted file will indicate whether an identifier exists. By transmitting and receiving only a portion of the entire digital work file, search time is reduced and the storage capacity of the work protection server 10 is preserved.

Thereafter, at step 300, the main server 11 determines whether corresponding identifiers exist by searching the received digital files for the identifiers (for example, water marks, MD5, SHA1 or the like), and the results of this determination are stored in the storage unit 12 in the form of data or in the database 13 of the main server 11.

If identifiers identical with the identifiers inserted by the administrator exist in the received digital files, a corresponding file is judged, at step 310, to be a “pass” file. A “pass” file would indicate that the file is an authorized or legal copy of the digital work and this file should be included in the detected saturation calculation for the existing network. If the search results show that no identifier exists in the digital file, then at step 310, the file is deemed to be a “fail” file. A “fail” file would indicate that the file is an unauthorized or illegal copy of the digital work.

At step 330, an iterative process ensues whereby a determination is made as whether additional digital files exist and, if so, determinations are made on these files to assess whether the files have inserted identifiers (i.e., whether the files are “pass” files or “fail” files”.

After the main server 11 carries out the entire judgment process, at step 340, the main server 11 may calculate a detected saturation at step 340. The detected saturation value being the percentage of “pass” files for a particular work existing in the communication network versus the total number of files for that work existing in the communication network.

The calculated detected saturation value may be provided to clients and be used by the administrator as reference data to administer the work protection server 10. In one embodiment of the invention the calculated detected value is compared to a predetermined target saturation value to determine the quantity of authorized or legal copies of the digital work that must be disseminated into the communication network in order to meet the target saturation value.

Thereafter, at step 350, the main server 11 generates the files to be shared, i.e., the file list (i.e., the “non-downloadable” file), the distorted/noisy/encrypted file and the redirection file, in accordance with the copyright owner's instructions if these files have not already been generated and stored in the storage unit 12. The work protection server 10 also generates information about the digital files to be shared (such as the file list information identifying the IP address and file feature information that will be provided to a user as the result of a search for the respective digital work) and stores the information in the database 13.

At step 360, the main server 11 determines the distribution of system resources according to searched work lists. That is, auxiliary servers that have been determined to have shared the digital files are determined according to the searched work lists, and connection information is provided by the auxiliary servers according to the lists, for example, IP addresses and port numbers relating to corresponding intermediate servers that have shared the digital files. This connection information may be stored in the storage unit 12 or database 13 of the main unit 11.

After the main server 11 finishes the above-described steps, at step 370, the main server 11 proceeds from a current list to a next list, or terminates a control operation.

In operation, a user may input a query for one or more digital works as identified by particular artist or title, for example. If the digital work(s) are protected according to the present invention, the actual saturation of the digital work(s) within the network is determined, either by surveying the network as described above or, more likely, by recalling the value for the actual saturation of the digital work(s) that was determined and stored at the time that the digital work(s) were registered. The number of responses that must be provided by the main server 11 to cause the list of responses received by the user in response to the query to have the predetermined or desired saturation is determined. For example, a user is generally presented with a file list identifying a number of files accessible via the network that meet the requirements of the query. Typically, each file in the file list is identified by IP address or the like and additional file feature information may be provided. According to the present invention, the main server 11 provides a sufficient number of responses to the query (with each response provided by the main server representing a link to a file list (i.e., the “non-downloadable” file), the distorted/noisy/encrypted file and the redirection file) such that the resulting list presented to the user has a percentage of links to authorized versions of the digital work relative to the total number of links (both authorized and unauthorized) that equals or exceeds the predetermined or desired saturation value. The user then generally selects one of the links from the listing so as to access the digital work represented by the link.

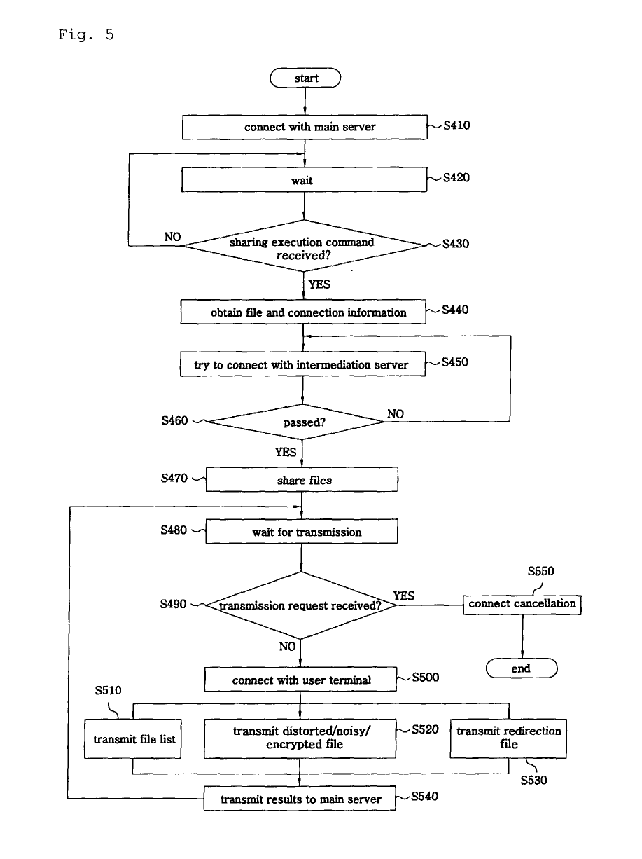

Next, a process of connecting with a corresponding intermediate server 30 under the control of the main server 11 and causing digital works to be shared is described with reference to FIG. 5, in accordance with an embodiment of the present invention. As will be apparent, the sharing of the digital work by the intermediate server 30 is generally performed in response to the selection by the user of a link associated with the digital work from among the various links presented in the listing resulting from the user's query.

When the administrator applies power to the auxiliary server 15 to operate and execute the sharing program of the auxiliary server 15 stored in the auxiliary server 15, the sharing program is loaded in the main memory of the auxiliary server 15 and executed by a processor.

At step 410, the auxiliary server 15 accesses the preset communication port of the main server 11 via the communication network 60 and, at step 420, the auxiliary server waits for communication from the main server.

The auxiliary server 15 determines, at step 430, whether a sharing execution command has been received from the main server 11 via an internal communication line. If the sharing execution command has not been received from the main server 11 as the result of the determination, the auxiliary server 15 returns and waits.

If the sharing execution command has been received from the main server 11 via the internal communication line, at step 440, the auxiliary server 15 obtains information about connection with the intermediate server 30 and information about files to be shared. A method for obtaining information may be exemplified by a method in which the main server 11 transmits a sharing execution command, searches data stored in the storage unit 12 and the database 13 and transmits the connection information and the file information. Additionally, the method may involve the auxiliary server 15 accessing information stored in the storage unit 12 and the database 13 and reading out the connection information and the file information.

Thereafter, at step 450, the auxiliary server 15 accesses the intermediate server 30 according to the obtained connection information and tries to log in by inputting an ID and a password.

Thereafter, at step 460, the auxiliary server 15 determines whether a signal relating to the success of logging in and the allowance of access has been received from the intermediation server 30 after a certain period of time. If the access is allowed, list information about shared digital files is shared, at step 470. This list information can then be freely read by users by transmitting the list information to the intermediate servers 30. If the access fails, the auxiliary server 15 connects with the intermediate server 30 and re-initiates the log-in process.

At step 480, the auxiliary server 15 waits to transmit corresponding digital files when a request for the transmission of the digital files is received from the user terminals 40 that are connecting with the intermediate servers 30. Thereafter, at step 490, the auxiliary server 15 determines whether the request for the transmission of digital files has been received from a user terminal 40.

If the request for the transmission of digital files is received from a user terminal 40, then at step 500, the auxiliary server 15 opens its communication port to the user terminal 40, and requested information is transmitted to the user terminal 40 through the opened communication port

Thereafter, the auxiliary server 15 transmits the requested digital files to the user terminal 40, in which the transmitted digital files are processed according to the above-described distortion/noise/encryption, “no-downloading” or redirection option. In the case of works for which the “no-downloading” option is selected, at step 510 only file lists are transmitted to the user terminal. In the case of works for which the distortion/noise/encryption option is selected, at step 520, a distorted/noise/encrypted digital file is transmitted to the user terminal. In the case of works for which the redirection option is selected, at step 530, digital files having redirection information are transmitted to the user terminal.

A method for transmitting the digital files may be exemplified by a method of previously receiving corresponding files from the main server 11, storing these files in the main server 11 and transmitting these files to user terminals that request the transmission of these files. Additionally, an alternate method is defined as reading digital files from the main server 11 through an internal communication line and transmitting these digital files to a user terminal 40 whenever the transmission of these digital files are requested by the user terminal 40.

If the transmission has been completed, at step 540, the auxiliary server 15 transmits the details of transmitting the work file, such as a file name, transmission time and the like, to the main server 11.

If the work protection server 10 has not received a request for the transmission from the user terminal 40 for a certain predefined period of time during waiting for the transmission, at step 550, the work protection server 10 receives a command to log out from the main server 11 and disconnects from the intermediation server 30.

A user, who receives a digital file distributed through the communication network 60 in accordance with the present invention, usually executes the received digital file. In the case where the executed digital file is a file for which the distortion/noise/encryption option is selected, this distorted/noisy/encrypted digital file is executed in a distorted/noisy/encrypted manner. In the case where the executed digital file is a file for which the “no-download” option is selected, only a search list is provided and the digital file is not downloaded. In the case where the executed digital file is a file for which the redirection option is selected, the redirection file causes the user terminal 40 to be redirected to a corresponding Web site.

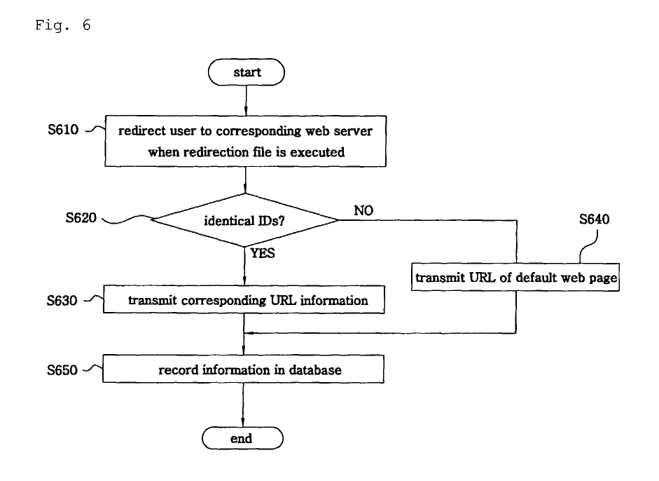

FIG. 6 is a flowchart showing a process of redirecting a user to a corresponding Web site when a digital file, for which the redirection option is selected, is executed, in accordance with an embodiment of the present invention.

Once the user executes a corresponding digital work file having a redirection option, at step 610, a default browser, preset in the computer of the user, is executed, the address and unique ID of a redirection Web server are read from the redirection file and the redirection Web server is accessed by the user terminal. In this case, a redirection Web server page is different from a general Web page in that it is not displayed. Instead, the Uniform Resource Locator (URL) of a Web site corresponding to the unique ID of the redirection Web server is retrieved from a database, and a home page of a related author, a music producer or a software company may subsequently linked in the Web browser of the user as described below.

Thereafter, at step 620, a determination is made whether the ID of the corresponding file, i.e., the ID stored in the redirection file, is identical with the ID of the redirection Web server. If the ID of the corresponding file is identical with the ID of the redirection Web server, at step 630, information about a corresponding URL is transmitted and the user terminal is redirected to this URL and the home page of the author, music producer or software company or a more particular page about the respective digital work may be presented. If the ID of the corresponding file is not identical with the ID of the redirection Web server then at step 640, information about the URL of a default Web page is transmitted and the user terminal is redirected to this URL. The default Web page may be constructed in any desired manner, but typically provides an indication that an error has occurred and suggests the next action that the user should take.

At step 650, information about all users (such as IP addresses) linked in the redirection Web server and information about matched files are recorded in the database 13 of the main server 11.

As described above, the present invention provides a system and method for protecting works, which is capable of distributing authorized or legal files to mitigate the unauthorized or illegal copies that exist in a P2P shared file communication network. In effect, the present system serves to increase both the on-line and off-line sales of copyrighted digital works.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for protecting digital works in a communication network, the digital works being shared in a peer-to-peer manner via the communication network among a plurality of user terminals, the system comprising:
one or more intermediate servers for performing intermediation of data shared via the communication network;
one or more list provision servers for providing list information to the intermediate servers; and
a work protection server for connecting with a corresponding intermediate server according to list information provided by the list provision server, searching for digital work files shared via the intermediate server using a preset search condition, calculating a detected saturation by examining the presence of identifiers in the searched digital work files, generating file and connection information about authorized digital work files, and causing the authorized digital works to be shared on the communication network in accordance with the detected saturation and a predefined targeted saturation.

2. The system according to claim 1, wherein the work protection server comprises:
a main server for connecting with a corresponding intermediate server recorded in list information provided by the list provision server, searching for digital work files shared via the intermediate server using the preset search condition, calculating a detected saturation by receiving the searched digital works and examining the presence of identifiers in the files of the searched digital work files, and generating file and connection information about authorized digital work files to be shared; and
one or more auxiliary servers for receiving the file and connection information about authorized digital work files to be shared via the communication network, connecting with the intermediate server and causing the authorized digital work files to be shared on the communication network.

3. The system according to claim 1, wherein the digital files are selected from the group consisting of a corrupt downloadable file, an encrypted downloadable file, a non-downloadable file having an associated file list, and a redirection file.

4. The system according to claim 3, further comprising one or more Web servers to which users are redirected when a redirection file is executed.

5. A method of protecting digital works on a communication network, the digital works being shared in a peer-to-peer manner via the communication network among a plurality of user terminals, comprising the steps of:
generating authorized digital work files that include the type of protection from the group consisting of a corrupt downloadable file, an encrypted downloadable file, a non-downloadable file and a redirection file, and that are marked by identifiers;
searching for digital work files shared on the communication network, and determining whether the searched works are authorized by examining the presence of identifiers in the searched digital work files;
distributing information about the authorized digital works in response to a user query for a respective digital work such that at least some of the responses received by the user terminal are based upon information regarding the authorized digital works, thereby mitigating existence of unauthorized digital works on the communication network; and
transmitting the authorized digital work file including one of a corrupt downloadable file, an encrypted downloadable file, a non-downloadable file and a redirection file when the user requests transmission of the authorized digital work file.

6. The method according to claim 5, further comprising the step of redirecting users to a corresponding Web server when the redirection file is executed.

7. A method of protecting digital works on a communication network, the digital works being shared in a peer-to-peer manner via the communication network among a plurality of user terminals, comprising the steps of:
inserting identifiers into authorized digital work files, and storing the authorized digital work files;
searching, on the communication network, for shared digital work files;
receiving at least a portion of the shared digital work files and examining the portion for presence of an identifier;
determining a detected saturation of the shared digital work files, the detected saturation being defined as the number of shared digital work files available on the communication network that have an identifier versus the total number of shared digital work files available on the communication network;
determining a number of the authorized digital work files that require network distribution to satisfy a predetermined target saturation;
providing a user host with information about each of the number of authorized digital work files in response to a query from the user host relating to the respective digital work; and
distributing one of the authorized digital work files to a user host when the user terminal requests transmission of the digital work files.

8. The method to claim 7, wherein the identifiers are water marks.

9. The method to claim 7, wherein the digital work files are selected from the group consisting of a corrupt downloadable file, an encrypted downloadable file, a non-downloadable file having an associated file list, and a redirection file.

10. The method according to claim 7, further comprising the step of redirecting a user to a corresponding Web server when the redirection file is executed.

11. The method according to claim 7, wherein determining a number of the authorized digital work files that require network distribution to satisfy a predetermined target saturation further comprises the step of calculating a saturation that is a ratio of the number of pass determinations to the total number of determinations and computing the number of authorized digital work files to be distributed, after the step of examining the portion for a presence of an identifier.
